(19) United States
(12) Patent Application Publication
(10) Pub. No.: US 2007/0211764 A1
(43) Pub. Date: Sep. 13, 2007

(54) Communication device, receiving method and computer program

(76) Inventors: Chihiro Fujita, Kanagawa (JP); Kazuyuki Sakoda, Tokyo (JP); Erika Saito, Tokyo (JP); Kenzoh Nishikawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/713,639

(22) Filed: Mar. 5, 2007

(30) Foreign Application Priority Data
Mar. 7, 2006 (JP) 2006-061372

(51) Int. Cl. H04J 3/00

(52) U.S. Cl. 370/498

(57) ABSTRACT

In order to reduce latency until when processing in accordance with each piece of header information included in a header is started, a communication device is provided with a header decoding portion (108) that decodes a received header; a post-decoding header output portion (112) that outputs the decoded header; a header error detection portion (106) that uses a header error-detecting code to check whether there are any errors in the header; and a post-decoding header update portion (110) that, if an error is detected in the header by the header error detection portion, updates the decoded header output by the post-decoding header output portion. The header decoding portion starts header decoding before the header error detection portion checks whether there are any errors in the header, and the post-decoding header output portion starts to output the decoded header before the header error detection portion checks for errors.

### CROSS REFERENCE TO RELATED APPLICATIONS

The present invention contains subject matter related to Japanese Patent Application JP 2006-61372 filed in the Japan Patent Office on Mar. 7, 2006, the entire contents of which being incorporated herein by reference.

### BACKGROUND OF THE INVENTION

1. Field of the Invention

The invention relates to a communication device, a receiving method, and a computer program, and more particularly to a communication device that receives a packet including a header and a header error-detecting code, a method for receiving a packet, and a computer program.

2. Description of the Related Art

When a plurality of communication devices are used to transmit and receive a packet, generally, the packet includes a header and a payload. The header includes information related to the packet such as the communication device that is the source of the transmitted packet, the communication device that is the destination for the transmitted packet, and the packet length (hereinafter, the various pieces of information included in the header are referred to as “header information”). The payload is the main body of the data that is being transmitted from the source communication device to the transmission destination communication device.

The packet includes an error-detecting code that is provided in case an error occurs in the data due to noise or the like in the communication channel. Normally, the packet includes a header error-detecting code for detecting an error in the header, and a payload error-detecting code for detecting an error in the payload.

In related art, when a communication device receives the packet, first, the header is received, and then the header is decoded in order to extract and obtain the various pieces of header information included in the header. Then, the communication device uses the head error-detecting code to check whether there are any errors in the header. If the check does not identify any errors, the communication device performs processing in accordance with the obtained header information. This processing in accordance with the header information may be, for example, processing that acquires information related to the source communication device from which the header was transmitted, or processing that interrupts receiving of the packet if the destination of the packet is not the given local device. After that, the communication device receives the payload and uses the payload error-detecting code to check whether there are any errors in the payload.

Technology that performs a determined process after the header information has been checked is disclosed, for example, in Japanese Patent Laid-open Publication No. JP-A-2004-320359. A receiving device disclosed in JP-A-2004-320359 performs post-processing like dividing multiplexed information after it has been checked that the header information is correct.

Technology that starts a determined process before the header information is checked is disclosed, for example, in Japanese Patent Laid-open Publication No. JP-A-Hei-11-215136. A wireless transmission device disclosed in JP-A-Hei-11-215136 checks the destination address included in the header before detecting errors in the header. If the destination is not the given local device, receiving processing is interrupted.

### SUMMARY OF THE INVENTION

However, in known communication devices such as that disclosed in JP-A-2004-320359, as described above, processing in accordance with the header information is not performed until after the header error detection processing is completed. Accordingly, there is an increase in latency until processing in accordance with the header information is started.

On the other hand, with the wireless transmission device disclosed in JP-A-Hei-11-215136, processing to check the destination address included in the header and processing in accordance with the destination address is performed before the header error detection. However, the other processing related to the header information is performed after the header error detection processing is completed. Accordingly, the technology disclosed in JP-A-Hei-11-215136 is not able to adequately address the issue of the increase in latency until processing in accordance with the header information is started.

Thus, it is desirable to provide a communication device that receives a packet including a header and a header error-detecting code, a receiving method, and a computer program, which can reduce latency until when processing in accordance with various pieces of header information included in the header is started.

According to an embodiment of the present invention, there is provided a communication device that receives a packet including a header and a header error-detecting code. The communication device includes: a packet receiving portion for receiving the packet; a header decoding portion that decodes the header received by the packet receiving portion; a post-decoding header output portion for outputting the decoded header that is decoded by the header decoding portion; a header error detection portion for checking whether there is an error in the header by using the header error-detecting code; and a post-decoding header update portion for updating the decoded header output by the post-decoding header output portion, if the header error detection portion detects an error in the header. The header decoding portion starts decoding the header before the header error detection portion checks whether there is an error in the header, and the post-decoding header output portion starts to output the decoded header before the header error detection portion checks whether there is an error in the header.

According to the above described structure, when the packet receiving portion in the communication device receives the packet, the header decoding portion decodes the header and the post-decoding header output portion outputs the decoded header before the header error detection portion checks whether there is an error in the header. Accordingly, the communication device can use the output decoded header to perform processing in accordance with the header without waiting for the header error detection. In addition, if it is determined that there is an error in the header based on the result of the error detection by the header error detection portion, the post-decoding header update portion updates the output header that includes the error. As a result, the communication device can perform processing in accordance with the header without waiting for the header error detection, and if there is an error in the header, can update the header including the error in order to perform appropriate processing.

The communication device may include a processing execution portion for performing processing in accordance with the decoded header output by the post-decoding header output portion. When the processing execution portion receives the decoded header from the post-decoding header output portion, the processing execution portion may perform processing in accordance with the header without waiting for the result of the error detection performed by the header error detection portion. According to this structure, the communication device can perform processing in accordance with the header without waiting for the result of the header error detection, thereby allowing latency from when the header is received until when processing in accordance with the header is performed to be reduced.

The header may include information related to a transmission destination of the packet including the header. If this configuration is adopted, the processing execution portion may interrupt receiving of the packet by the packet receiving portion if the transmission destination is not the communication device. According to this structure, if the received packet is not addressed to the communication device, the communication device can interrupt receiving of the packet without waiting for the result of the header error detection.

The header may include information related to a function necessary to receive the packet including the header. If this configuration is adopted, the processing execution portion may interrupt receiving of the packet by the packet receiving portion if the communication device does not have the function necessary to receive the packet. According to this structure, in the case that the communication device does not have the function needed to complete receiving of the received packet, the communication device can interrupt receiving of the packet without waiting for the result of the header error detection.

The information related to the function necessary to receive the packet may includes at least one of information related to a transmission rate of a payload of the packet, information related to whether the packet is fragmented, and information related to the type of method used for encoding/encrypting the payload of the packet.

The header may include identification information that identifies a source communication device that is a transmission source of the packet including the header. If this configuration is adopted, the processing execution portion may start acquiring information related to the source communication device identified by the identification information. The information related to the source communication device identified by the identification information may be, for example, information related to the source communication device acquired from previous communication between the communication device (namely, the communication device of the embodiment) and the source communication device. This information may be stored in a memory or the like of the communication device. Accordingly, when the communication device identifies the source communication device using the identification information included in the header, the communication device starts acquiring information related to the source communication device that is pre-stored in the memory etc. According to this structure, the communication device starts acquiring information related to the source communication device, which is needed for the processing that is performed on the received data after the header error detection processing, without waiting for the header error detection processing. As a result, the communication device can acquire the information related to the source communication device before the time when it is required, thereby allowing latency to be reduced.

The packet receiving portion may receive a frame including a plurality of multiplexed packets and a plurality of headers.

Each time the packet receiving portion receives one of the plurality of headers, the header decoding portion may start decoding the given header.

The frame may include at least one of the header error-detecting code, with each one of the header error-detecting codes being attached to each two or more of the headers. The total number of the header error-detecting codes included in the frame may be smaller than the total number of the headers included in the frame.

According to another embodiment of the present invention, there is provided a program for directing a computer to function as the above-described communication device. The computer program is stored in a memory device provided in the computer. A CPU provided in the computer reads and performs the computer program, thereby causing the computer to function as the above-described communication device. In addition, a recording medium on which the computer program is recorded and which can be read by the computer is provided. The recording medium may be, for example, a magnetic disk or an optical disk.

According to another embodiment of the present invention, there is provided a receiving method for receiving a packet including a header and a header error-detecting code. The receiving method includes the steps of: receiving the header; decoding the received header; outputting the decoded header; checking whether there is an error in the header by using the header error-detecting code; and updating the output decoded header if an error is detected in the header.

According to the embodiments of the present invention described above, the communication device that receives the packet including the header and the header error-detecting code can reduce latency until when processing in accordance with the various pieces of header information included in the header is started.

### BRIEF DESCRIPTION OF THE DRAWINGS

FIG. 1 is an explanatory diagram that shows an example of the structure of a packet that can be applied to an embodiment of the present invention;

FIG. 2 is an explanatory diagram that shows an example of the structure of a packet that can be applied to the embodiment of the present invention;

FIG. 3 is an explanatory diagram that shows an example of the structure of a packet that can be applied to the embodiment of the present invention;

FIG. 4 is an explanatory diagram that shows an example of the structure of a packet that can be applied to the embodiment of the present invention;

FIG. 5 is a flow chart showing a known packet receiving method;

FIG. 6 is a flow chart showing a known packet receiving method;

FIG. 7 is a block diagram showing the structure of a communication device according to the embodiment of the present invention;

FIG. 8 is a flow chart showing a packet receiving method used by the communication device according to the embodiment;

FIG. 9 is a flow chart showing a specific example of the processing of step S106 of FIG. 8; and

FIG. 10 is a flow chat showing the packet receiving method used by the communication device according to the embodiment in more detail.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure and denoted with the same reference numerals, and repeated explanation of these structural elements is omitted.

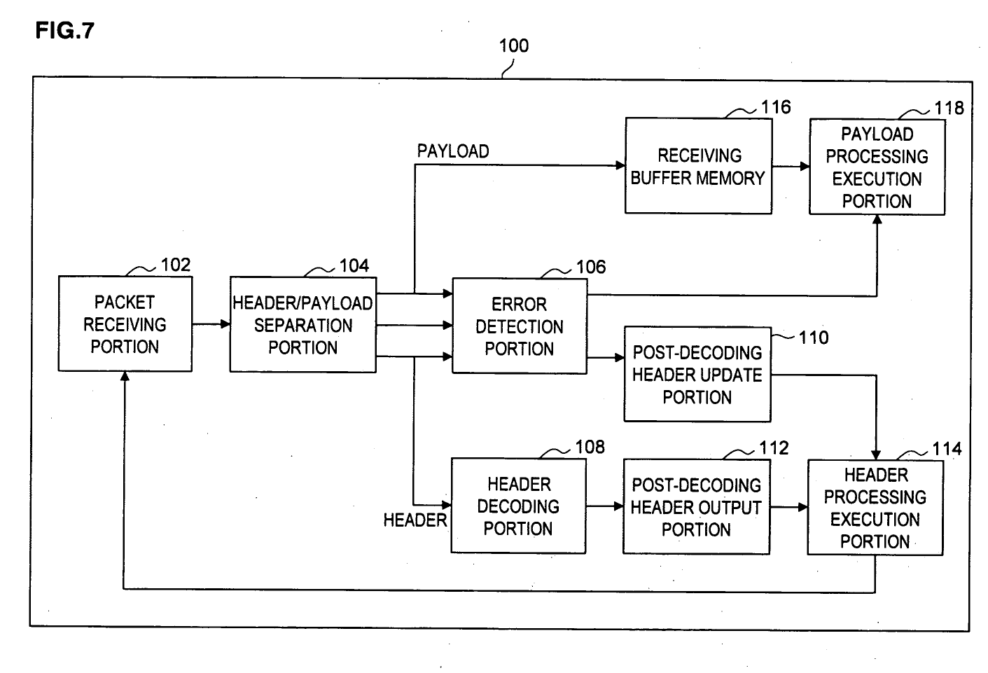

A communication device according to an embodiment of the present invention will be explained with reference to an applied example of a communication device 100 that can receive a packet by radio communication. The detailed structure of the communication device 100 will be explained later with reference to FIG. 7. Concrete examples of the type of radio communication system used include Ultra Wide Band (UWB), wireless LAN (IEEE 802.11a/b/g), and Bluetooth. Note that, the present invention is not limited to this example, and may be applied to a communication device that receives a packet using cable communication such as the Ethernet (Registered Trademark).

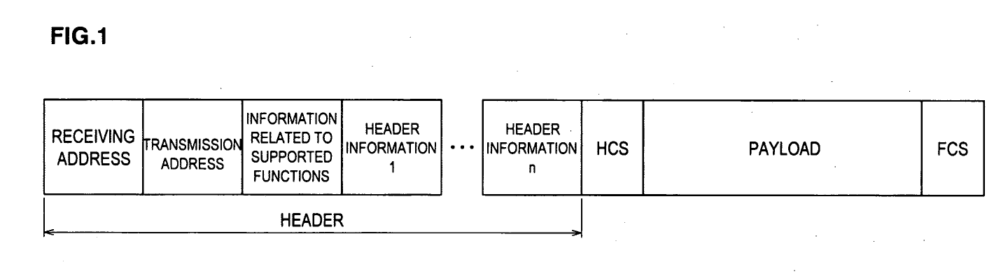

First, the structure of the packet received by the communication device 100 will be explained with reference to FIGS. 1 to 4. FIG. 1 shows the structure of the packet information according to the present embodiment. Referring to FIG. 1, the packet includes a header, a payload, an error-detecting code for the header, and an error-detecting code for the payload.

Next, each piece of information (namely, the header information, the header error-detecting code, the payload, and the payload error-detecting code) included in the packet will be explained individually.

First, the header information of the packet will be described. The header includes various pieces of information related to the packet that includes the header, and the payload included in the packet. Note that, hereinafter, the various pieces of information included in the header will be referred to as “header information”. More concretely, the header information may include, as shown in FIG. 1, information like the receiving address of the packet, the transmission address, and information related to supported functions.

The receiving address is the address of the transmission destination of the packet, and more specifically is identification information for the communication device that is to receive the packet. The communication device 100 obtains the receiving address included in the header of the received packet, and uses this information to determine whether the packet is addressed to the given local device.

The transmission address is the address of the transmission source of the packet, and more specifically is identification information for the communication device that is the source of the transmitted packet. Hereinafter, the communication device that is the transmission source of the packet will be referred to as “transmission source device”. The communication device 100 obtains the transmission address included in the header of the received packet and uses this information to identify the transmission source device of the packet.

The information related to supported functions is information related to functions that are necessary to receive the packet. More concretely, the information related to supported functions may include, for example, information related to the transmission rate of the payload, information related to the presence/lack of fragment processing, and information related to the type of encoding/encryption method used for the payload.

Next, the various pieces of information related to the supported functions (for example, the information related to the transmission rate of the payload, the information related to the presence/lack of fragment processing, and the information related to the encoding/encryption method of the payload) will be described.

The transmission rate of the payload is the transmission speed when the payload included in the packet is transmitted, and is specified by the transmission source device of the packet. If the communication device 100 is not able to support the specified transmission rate, the communication device 100 cannot receive the payload transmitted from the transmission source device at the specified transmission rate. Accordingly, the communication device 100 can obtain the information related to transmission rate included in the header of the received packet, and use this information to determine whether the payload can be received.

The presence/lack of fragment processing is information that indicates whether the packet is fragmented. More specifically, if the transmission source device divides each packet up into a plurality of packets (fragmentation) and then transmits the packets, each divided up packet is referred to as a fragmented packet. In the case that received packets are fragmented packets, the communication device on the receiving side joins the packets together, etc. in order to reassemble the pre-fragmentation packet and obtain the information. Note that, if the communication device 100 does not have a reassembly function for reassembling the pre-fragmentation packet from the plurality of fragmented packets, even if the communication device 100 receives the packet, it cannot obtain this information. Accordingly, the communication device 100 can obtain the information related to the presence/lack of fragmentation processing included in the header of the received packet in order to determine whether or not to receive the packet. For example, if the communication device 100 receives a packet that has fragmentation processing (namely, the packet is a fragmented packet), and the communication device 100 does not have the above reassembly function, the communication device 100 may determine not to receive the packet.

In addition, the communication device 100 can obtain the information related to the type of encoding/encryption method of the payload, and use this information to determine whether it can decrypt the payload. Accordingly, the communication device 100 can obtain the information related to type of encoding/encryption of the payload included in the header of the received packet, and use this information to determine whether or not to receive the packet. For example, if the communication device 100 cannot decrypt the payload included in the packet, the communication device 100 may determine not to receive the packet.

The header information included in the header may also include, in addition to the above-described information, the packet length, the payload length, or the like.

Next, the header error-detecting code of the packet will be explained. The header error-detecting code is information for detecting whether there are any errors in the header. In FIG. 1, the header error-detecting code is shown as a Header Check Sequence (HCS). The error-detecting code is a systematic code that is independent from all the other pieces of header information in the header, and may be, for example, CRC, or Reed-Solomon code. In the present embodiment, before the error-detecting code is used to detect errors in the header, processing in accordance with the header information is performed. Thus, the above-mentioned systematic code is used for error detection rather than a non-systematic code that changes the header information in order to detect errors. Note that, the error-detecting code includes an error-correcting code that is used to correct any errors in the header.

Next, the payload of the packet will be explained. The payload is the main body of the data that the transmission source device is transmitting to the transmission destination communication device.

Finally, the error-detecting code for the payload of the packet will be explained. The payload error-detecting code is information that is used to detect whether there are any errors in the payload. In FIG. 1, the payload error-detecting code is shown as a Frame Check Sequence (FCS). The payload error-detecting code may be a systematic code or a non-systematic code. In the present embodiment, in order to allow the same logic to be used to perform a header error-detecting process and a payload error-detecting process, the payload error-detecting code is a systematic code like the header error-detecting code.

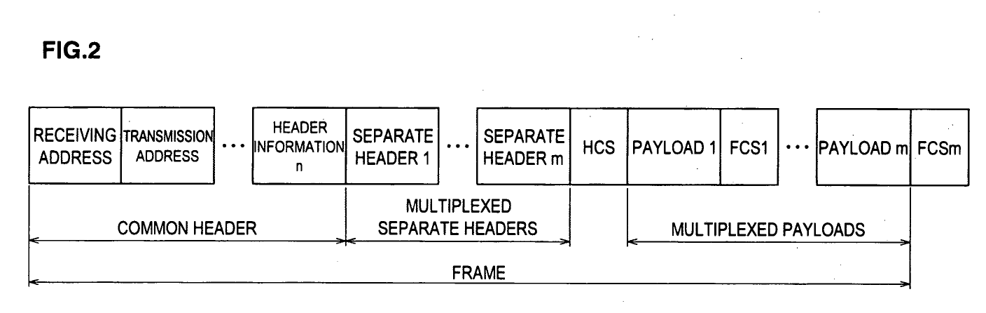

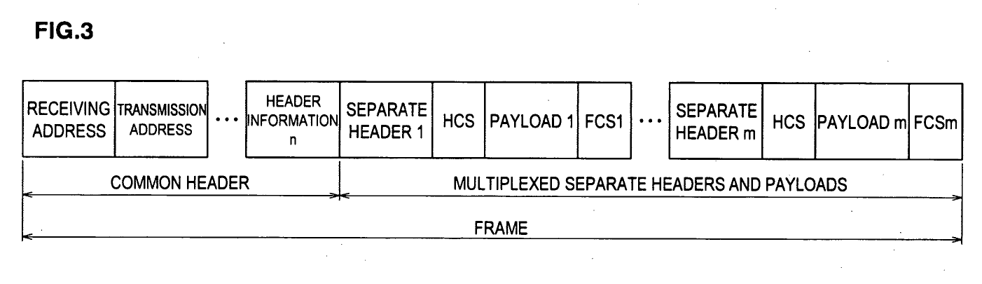

The communication device 100 according to the present embodiment receives the packet with the structure like that described in FIG. 1. Moreover, the communication device 100 can also receive a multiplexed packet that is formed by multiplexing a plurality of packets. Hereinafter, the plurality of multiplexed packets will be referred to as a “frame”. The structure of the frame is shown in FIGS. 2 and 3.

Referring to FIG. 2, the frame includes a plurality of headers and a plurality of payloads. The plurality of headers include a common header and separate headers. The common header includes header information that is common to the plurality of payloads within the frame, such as the receiving address and the transmission address. The separate headers include header information that is separate for each payload, like the payload length, and the type of encoding/encryption method used. The example shown in FIG. 2 includes a single common header and a plurality of separate headers, with a single header error-detecting code HCS attached to all of the headers. More specifically, a single header error-detecting code HCS is attached to two or more headers, and thus the total number of header error-detecting codes included in the frame is less than the total number of the headers included in the frame.

FIG. 3 shows an example of another frame. The frame shown in FIG. 3 includes a single common header and a plurality of separate headers like the example shown in FIG. 2. In the frame shown in FIG. 3, a header error-detecting code HCS is attached to each separate header 1 to m.

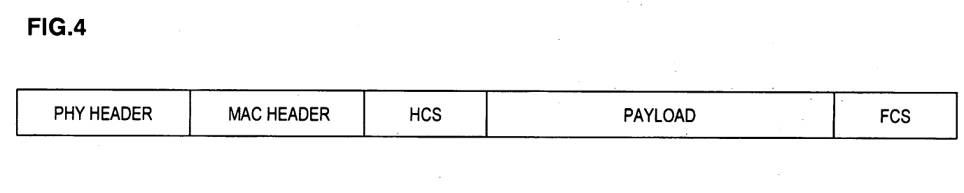

FIG. 4 shows an example of the structure of another packet. The packet shown in FIG. 4 includes a PHY (physical layer) header and a MAC (media access control layer) header. A single header error-detecting code HCS is attached to the two headers.

This completes the explanation of the structure of the packet received by the communication device 100. Note that, the present invention is not limited to the above-described examples, and may be applied to any packet that includes a header and a header error-detecting code.

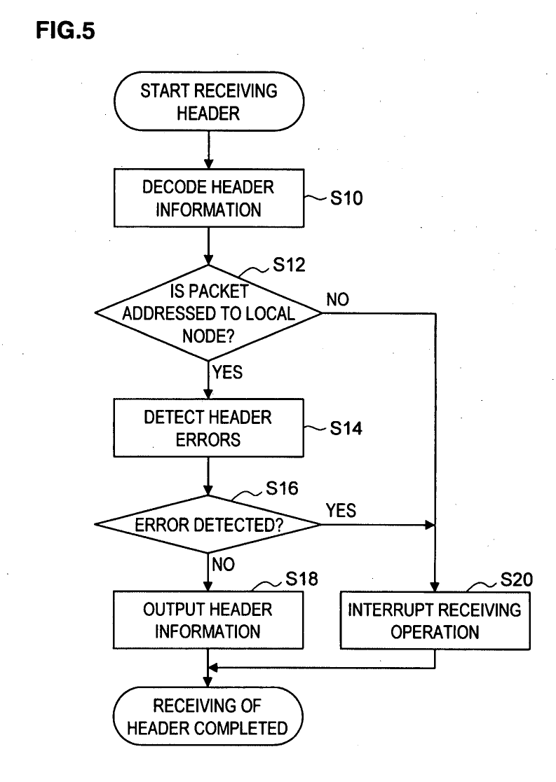

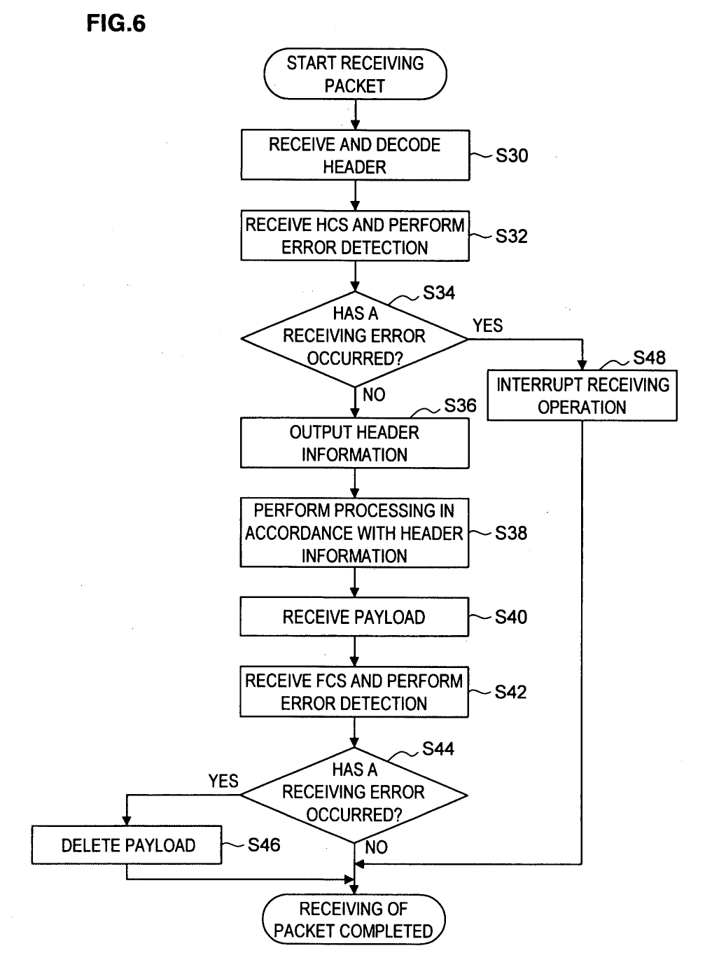

Next, FIGS. 5 and 6 will be used to explain the difference between the packet receiving method used by the communication device 100 according to the present embodiment and generally known packet receiving methods. FIG. 5 illustrates the flow of a known header receiving method, and FIG. 6 illustrates the flow of a packet receiving method that is performed by a known communication device.

First, as shown in FIG. 5, the known communication device receives the header and decodes the header information (step S10). More specifically, the various pieces of header information included in the header are obtained by extracting them from the header. Next, the communication device uses the receiving address, which is one of the pieces of header information, as a basis for determining whether the packet is addressed to the local node (step S12). If the packet is not addressed to the local node, the communication device interrupts the packet receiving operation (step S20).

On the other hand, if the packet is addressed to the local node, the communication device uses the header error-detecting code to perform header error detection (step S14). The communication device uses the result of the error detection as a basis for determining whether there are any errors in the header (step SI 6). If there are any errors, the packet receiving operation is interrupted (step S20).

On the other hand, if there are no errors, the communication device outputs the header information (step S18). More specifically, the communication device outputs the various pieces of header information obtained by decoding in step S10 to a processing portion that performs processing in accordance with the header information. Then, the processing portion performs the processing in accordance with each piece of header information.

As shown in FIG. 6, first, the known communication device receives the header, and performs decoding (step S30). Next, the communication device receives the HCS (the header error-detecting code), and performs header error detection (step S32). The communication device then uses the result of the error detections as a basis for determining whether an error has occurred (step S34). If an error has occurred, the communication device interrupts the receiving operation (step S48).

On the other hand, in the case that no error has occurred, the communication device outputs the header information obtained by decoding the header in step S30 (step S36), and performs processing in accordance with each piece of header information (S38). Then, the communication device receives the payload (step S40) and receives the FCS (the payload error-detecting code), and performs payload error detection (step S42). The communication device uses the result of the detection as a basis for determining whether an error has occurred in the received payload (step S44). If it is determined that an error has occurred, the communication device deletes the received payload (step S46).

This completes the explanation about the known packet receiving method. The above-described receiving method is used to check whether an error has occurred in the header after the header is decoded. In addition, after it is confirmed that there are no errors, the communication device outputs the header information and performs processing in accordance with the header information. In other words, the communication device outputs the header information and starts to perform processing in accordance with the header information after the header error detection processing is completed. Accordingly, the communication device holds the header information without outputting it to the processing portion that performs the next processing step until the header error detection is completed. As a result, the capacity of a storage device like a register that is used to hold the header information needs to be made larger in order to hold all of the header information included in the header.

Moreover, the processing in accordance with the header information can only be performed after the header error detection has been performed following extraction of all of the header information included in the header. Therefore, there is an increase in latency from when the header is received until when the processing in accordance with the header information is started. In particular, as shown in FIG. 2, when a plurality of multiplexed packets are included in a frame, and the frame includes a single error-detecting code attached to a plurality of headers, there is an even more substantial increase in latency.

Note that, the processing in accordance with the header information includes, for example, interrupting the packet receiving operation in the case that the transmission rate of the payload specified by the header information is a rate that the given communication device cannot support. In this case, even thought the packet cannot be received, the receiving operation is not interrupted until after the header error detection has been performed following extraction of all of the header information. Accordingly, in the intervening period, the receiving operation is continued, which results in wasteful power consumption.

The above-described problems that occur in the known receiving method are addressed by the communication device 100 according to the present invention. Next, the communication device 100 according to the present embodiment will be described in more detail.

First, the structure of the communication device 100 will be described with reference to FIG. 7. Referring to FIG. 7, the communication device 100 principally includes a packet receiving portion 102, a header/payload separation portion 104, an error detection portion 106, a header decoding portion 108, a post-decoding header update portion 110, a post-decoding header output portion 112, a header processing execution portion 114, a receiving buffer memory 116, and a payload processing execution portion 118.

In the present embodiment, each processing portion of the communication device 100 is structured by hardware in order to increase processing speed. However, the invention is not limited to this example, and each processing portion may be configured by software by installing respective programs that carry out the functions of each processing portion in the communication device.

The packet receiving portion 102 receives the packet transmitted from the transmission source device. In the present embodiment, in order to receive the packet transmitted by wireless communication, the packet receiving portion 102 includes an antenna, an RF circuit, a base band circuit, and the like.

The header/payload separation portion 104 separates the packet received from the packet receiving portion 102 into the header and the payload. More specifically, the header/payload separation portion 104 outputs the header included in the packet to the header decoding portion 108, outputs the header error-detecting code and the payload error-detecting code to the error detection portion 106, and outputs the payload to the receiving buffer memory 116.

The header decoding portion 108 decodes the header. More specifically, the header decoding portion 108 extracts and obtains each piece of header information included in the header. Then, the decoded header, namely, the various pieces of header information, are provided to the post-decoding header output portion 112.

The post-decoding header output portion 112 outputs the decoded header (the header information) obtained by the header decoding portion 108 to the header processing execution portion 114.

The header processing execution portion 114 obtains the header information from the post-decoding header output portion 112 and performs processing in accordance with the header information. More specifically, for example, the header processing execution portion 114 obtains the information related to the payload transmission rate, which is one example of the header information, and determines whether the communication device 100 can receive the payload at that transmission rate. If it is determined that the payload cannot be received, a message instructing interruption of receipt of the packet is sent to the packet receiving portion 102, which interrupts receiving of the packet.

In addition, the header processing execution portion 114 obtains the information related to the presence/lack of fragment processing, which is another example of the header information, and in the case there is fragment processing, it is determined whether the communication device 100 has a function that can obtain information from a fragmented packet. If the communication device 100 does not have such a function, a message instructing interrupt of receipt of the packet is sent to the packet receiving portion 102, which interrupts receiving of the packet.

In addition, the header processing execution portion 114 obtains the information related to the type of encoding/encryption method of the payload, which is another example of the header information, and determines whether the communication device 100 can decrypt the payload. If the payload cannot be decoded, a message instructing interruption of receipt of the packet is sent to the packet receiving portion 102, which interrupts receiving of the packet.

When the post-decoding header output portion 112 obtains the header information form the header decoding portion 108, the post-decoding header output portion 112 outputs the header information to the header processing execution portion 114 without waiting for the error detection portion 106 to perform the header error detection processing. Furthermore, the header processing execution portion 114 also obtains the header information from the post-decoding header output portion 112 and performs processing in accordance with each piece of header information without waiting for the error detection result.

The error detection portion 106 receives the header error-detecting code, and checks whether there are any errors in the header. The error detection portion 106 then supplies the detection result to the post-decoding header update portion 110. In addition, if an error is detected, the error detection portion 106 corrects the section containing the error, and supplies the corrected header information to the post-decoding header update portion 110. Note that, in the case that the error detection portion 106 does not have an error-correcting function, if there is an error in the header, appropriate header information is transmitted to the post-decoding header update portion 110. Here, the appropriate header information that is transmitted if there is an error in the header is, for example, an initial setting value.

If an error in the header is detected by the error detection portion 106, the post-decoding header update portion 110 updates the decoded header output from the post-decoding header output portion 112. More specifically, the post-decoding header update portion 110 obtains the corrected header information from the error detection portion 106, and outputs the corrected header information to the header processing execution portion 114, which overwrites the header information containing the error. Once the header information has been updated, the header processing execution portion 114 performs processing in accordance with the updated header information.

More particularly, in the case that an error-correcting code is used for the HCS, for example, the header processing execution portion 114 interrupts the receiving operation if it is determined that receiving of the payload is not possible at the transmission rate updated by the post-decoding header update portion 110 even if it is determined that receiving of the payload is possible at the transmission rate output from the post-decoding header output portion 112. In addition, in the case that any one of the pieces of header information is updated by the post-decoding header update portion 110, the header processing execution portion 114 may instruct the packet receiving portion 102 to interrupt the receiving operation. In other words, if any error is detected in the header, receiving of the packet is interrupted.

The payload is stored in the receiving buffer memory 116. The error detection portion 106 uses the payload error-detecting code to check whether there are any errors in the payload stored in the receiving buffer memory 116, and supplies the check result to the payload processing execution portion 118. In addition, if an error is detected and the error can be corrected, the error detection portion 106 corrects the section containing the error and supplies the corrected payload to the payload processing execution portion 118.

The payload processing execution portion 118 performs processing in accordance with the payload. More specifically, for example, the payload processing execution portion 118 performs processing such as generating a reply packet based on the contents of the payload. In addition, if an error is detected in the payload, the payload processing execution portion 118 may delete the received payload.

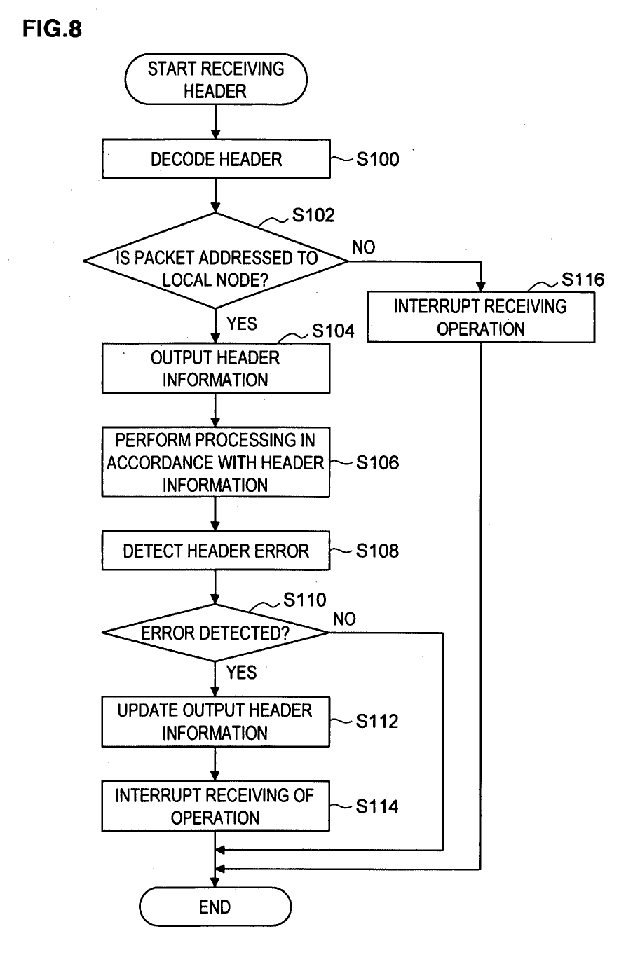

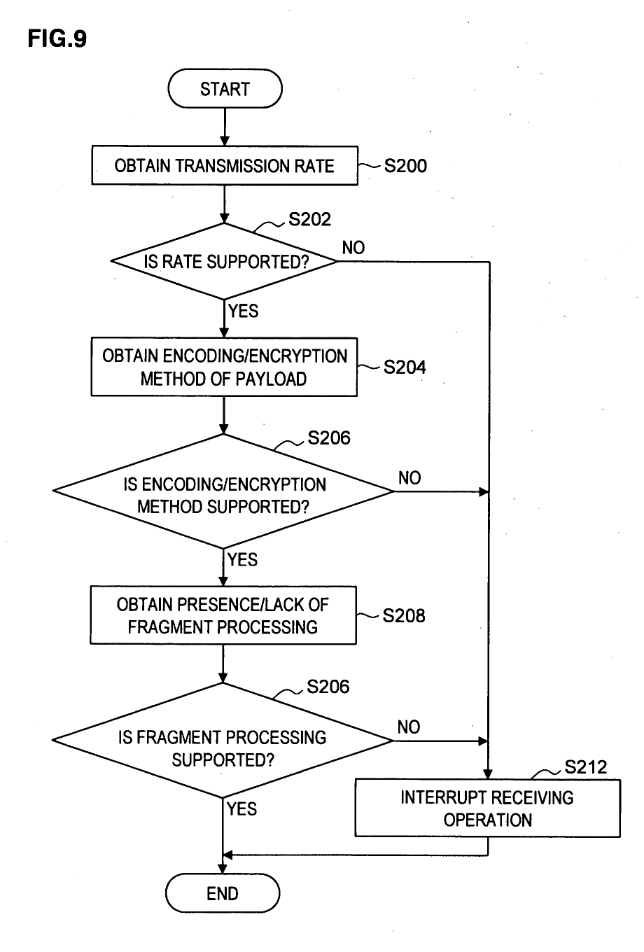

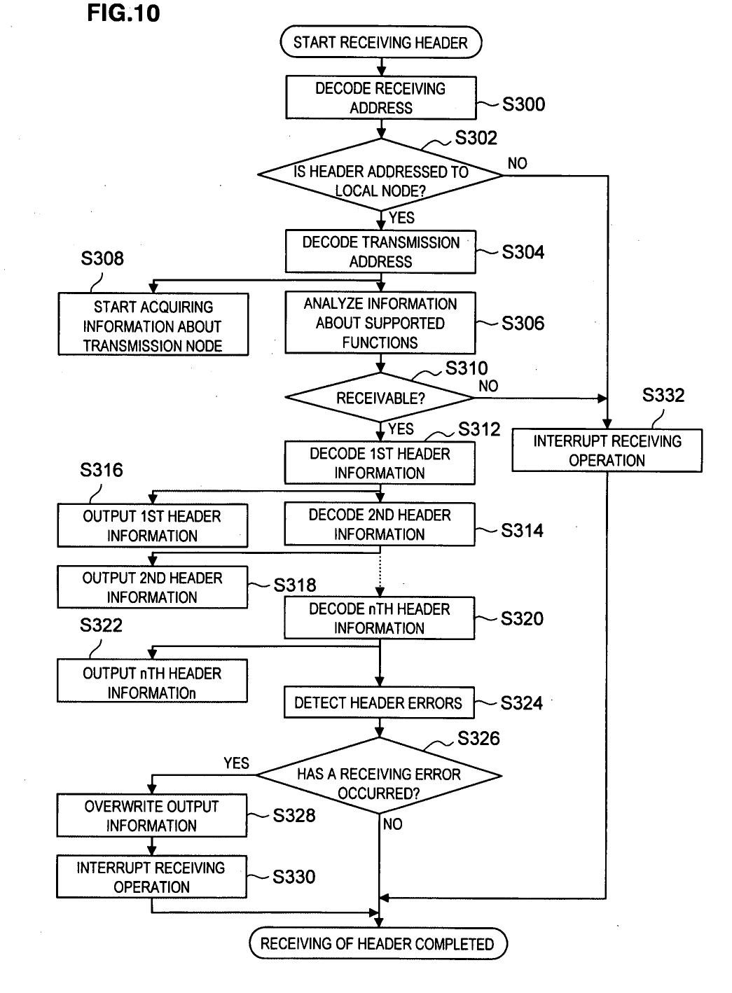

This completes the explanation of the structure of the communication device 100. Next, the packet receiving method used by the communication device 100 will be explained with reference to FIGS. 8 to 10. FIG. 8 shows the flow of a header receiving method used by the communication device 100, FIG. 9 shows a specific example of the processing of step S106 of FIG. 8, and FIG. 10 is a flow chart that illustrates the header receiving method used by the communication device 100 in more detail.

First, the communication device 100 receives the header and decodes the header (step S100). More specifically, the various pieces of header information included in the header are obtained by extracting them from the header. Next, the communication device 100 uses the receiving address, which is one of the pieces of header information, as a basis for determining whether the packet is addressed to the local node (namely, the local device 100) (step S102). If the packet is not addressed to the local node, the communication device 100 interrupts the packet receiving process (step S116).

On the other hand, if the packet is addressed to the local node, the communication device 100 outputs the header information (step S104), and performs processing in accordance with the header information (step S106). More specifically, the communication device 100 outputs the header information obtained in step S100 to the processing portion (the header processing execution portion 114) that performs the next processing step, namely, processing in accordance with the header information. The processing portion that performs the next processing step then performs the processing in accordance with the header information. Next, the communication device 100 uses the header error-detecting code to check whether there are any errors in the header (step S108), and uses the check result as a basis for determining whether there are any errors in the header (step S110). If there are no errors in the header, the communication device 100 continues the receiving process of the packet. On the other hand, if there is the error, the communication device 100 updates the output header information (step S112), and interrupts the packet receiving process (step S114). Note that, the updating process of the output header information and the interruption of the receiving process may be performed in the opposite order.

FIG. 9 shows a specific example of the processing of step S106 of FIG. 8. Referring to FIG. 9, the communication device 100 obtains the information related to the transmission rate, which is one of the pieces of header information (step S200). The communication device 100 then determines whether it supports the transmission rate (step S202). If the communication device 100 does not support the transmission rate, receiving of the packet is interrupted (step S212). However, if the communication device 100 supports the transmission rate, next, the communication device 100 obtains the information related to the type of encoding/encryption method, which is one of the pieces of the header information (step S204). The communication device 100 then determines whether it supports this method (step S206). If the communication device 100 does not support the method, receiving of the packet is interrupted (step S212). However, if the method is supported, next, the communication device 100 obtains the information related to the presence/lack of fragment processing, which is one of the pieces of header information (step S208). After obtaining this information, if there is fragment processing, the communication device 100 determines whether it supports a function to reassemble fragmented packets (step S210). If the communication device 100 does not support such a function, receiving of the packet is interrupted (step S212).

Next, FIG. 10 will be used to explain the header receiving method used by the communication device 100 in more detail. First, the communication device 100 receives the header, and decodes the receiving address (step S300). More specifically, the communication device 100 extracts the header information included in the head of the header to obtain the receiving address. Next, the communication device 100 uses the obtained receiving address as a basis for determining whether the packet is addressed to the local node (step S302). If the packet is not addressed to the local node, the communication device 100 interrupts the packet receiving process (step S332).

On the other hand, if the packet is addressed to the local node, the communication device 100 decodes the transmission address, which is the piece of header information included after the receiving address in the header (step S304). Then, the communication device 100 uses the obtained transmission address as a basis for starting to acquire information related to the transmission source device (step S308). The information related to the transmission source device is information that has been acquired by the communication device 100 from communication with the given transmission source device prior to receiving the present packet. This information includes, for example, values related to the send-receive buffer and ARQ, control information for data rate class, and packet error rates. This information is stored in a memory of the communication device 100. A plurality of processing units including the header decoding portion 108 can access this memory. Accordingly, after the transmission address has been decoded, information acquisition is started immediately, whereby the effect of latency that occurs during reading of the information is reduced. Note that, if the transmission source device is unknown, the communication device 100 reads pre-defined information for invalid transmission source information.

At the same time as acquiring information related to the transmission source device, the communication device 100 analyses the information (step S306) about the supported functions, which is the piece of header information included after the transmission address in the header. More specifically, the communication device 100, obtains the information related to the transmission rate and the type of encoding/encryption method of the payload etc. as the information related to the supported functions, as shown in FIG. 9. Then, the communication device 100 checks what functions it can support. Further, the communication device 100 determines whether it can receive the packet (step S310), and if the packet cannot be received, the communication device 100 interrupts the packet receiving operation (step S332).

On the other hand, if it is determined that the packet can be received, the communication device 100 decodes the other header information included in the header, and outputs the obtained header information to the processing portions that performs the next processing steps (steps S312, S316, S314, S318, S320, S322). Once decoding and output of all of the header information included in the header is completed, the communication device 100 uses the header error-detecting code to detect any errors in the header (step S324). The communication device 100 then uses the detection result to determine whether there is an error in the header or whether a receiving error has occurred (step S326). If an error has occurred, the communication device 100 overwrites the output header information (step S328), and interrupts the packet receiving operation (step S330).

This completes the explanation of the receiving method used by the communication device 100 according to the present embodiment. As a result of adopting the above-described configuration, the communication device 100 can output the header information and perform processing in accordance with the output header information without having to wait for the header error detection process to be completed. Thus, according to the communication device 100 of the present embodiment, latency from when the header is received until when processing in accordance with the header information is started can be reduced.

In addition, it is also possible to reduce the size of the capacity of the storage device such as the register for storing the header information in the period until when the header error detection process is completed because there is no need to store all of the header information without outputting it to the processing portions that perform the next processing steps. This is advantageous because circuit size can be reduced.

Moreover, the communication device 100 receives the header and then performs the processing in accordance with the header information in order. Accordingly, if it is determined that the given packet cannot be received based on one piece of header information, the communication device 100 can immediately interrupt the receiving operation without performing the following processing such as decoding the remaining header information or performing header error detection. As a result, the receiving operation for a packet that cannot be received is not continued for a long time, thereby reducing the amount of power that needs to be consumed in the receiving operation.

The communication device 100 is particularly effective in reducing latency, reducing circuit size, and reducing power consumption in the case of receiving a frame including a plurality of multiplexed packets and a plurality of headers, and where a single header error-detecting code is attached to the plurality of headers.

For example, in the case of receiving the frame shown in FIG. 2, the communication device 100 first receives the common header, decodes the common header, outputs the header information and performs processing in accordance with the output header information. Then, the communication device 100 sequentially receives the multiplexed separate headers. Each time a separate header is received, the communication device 100 decodes the separate header, outputs the header information, and performs processing in accordance with the header information. Next, once processing like that described above has been completed for all of the multiplexed separate headers, the HCS is received and used to detect any errors in the header. In this manner, the communication device 100 performs decoding, output and treatment processing each time a header is received in a multiplexed plurality of headers. Accordingly, as compared to known receiving methods in which output and treatment processing of each piece of header information is performed after error detection processing has been performed for all of the headers, latency, circuit size, and power consumption can be reduced substantially.

It should be understood by those skilled in the art that various modification, combinations, sub-combinations and alterations may occur depending on design requirements and other factors insofar as they are within the scope of the appended claims or the equivalents thereof.

What is claimed is:

1. A communication device that receives a packet including a header and a header error-detecting code, comprising:
a packet receiving portion for receiving the packet;
a header decoding portion that decodes the header received by the packet receiving portion;
a post-decoding header output portion for outputting the decoded header that is decoded by the header decoding portion;
a header error detection portion for checking whether there is an error in the header by using the header error-detecting code; and
a post-decoding header update portion for updating the decoded header output by the post-decoding header output portion, if the header error detection portion detects an error in the header; wherein
the header decoding portion starts decoding the header before the header error detection portion checks whether there is an error in the header, and the post-decoding header output portion starts to output the decoded header before the header error detection portion checks whether there is an error in the header.

2. The communication device according to claim 1, further comprising:
a processing execution portion for performing processing in accordance with the decoded header output by the post-decoding header output portion.

3. The communication device according to claim 2, wherein
the header includes information related to a transmission destination of the packet including the header, and
the processing execution portion interrupts receiving of the packet by the packet receiving portion if the transmission destination is not the communication device.

4. The communication device according to claim 2, wherein
the header includes information related to a function necessary to receive the packet including the header, and
the processing execution portion interrupts receiving of the packet by the packet receiving portion if the communication device does not have the function necessary to receive the packet.

5. The communication device according to claim 4, wherein
the information related to the function necessary to receive the packet includes at least one of information related to a transmission rate of a payload of the packet, information related to whether the packet is fragmented, and information related to the type of method used for encoding/encrypting the payload of the packet.

6. The communication device according to claim 2, wherein
the header includes identification information that identifies a source communication device that is the source of the transmitted packet including the header, and
the processing execution portion starts acquiring information related to the source communication device identified by the identification information.

7. The communication device according to claim 1, wherein
the packet receiving portion receives a frame including a plurality of the packets that have been multiplexed and a plurality of the header.

8. The communication device according to claim 7, wherein
each time the packet receiving portion receives one of the plurality of headers, the header decoding portion starts decoding the given header.

9. The communication device according to claim 7, wherein
the frame includes at least one of the header error-detecting code, each one of the header error-detecting codes being attached to two or more of the headers, and the total number of the header error-detecting codes included in the frame is smaller than the total number of the headers included in the frame.

10. A program for directing a computer, wherein the computer is caused to function as a communication device comprising:
a packet receiving portion for receiving a packet including a header and a header error-detecting code;
a header decoding portion that decodes the header received by the packet receiving portion;
a post-decoding header output portion for outputting the decoded header that is decoded by the header decoding portion;
a header error detection portion for checking whether there is an error in the header by using the header error-detecting code; and
a post-decoding header update portion for updating the decoded header output by the post-decoding header output portion, if the header error detection portion detects an error in the header; wherein
the header decoding portion starts decoding the header before the header error detection portion checks whether there is an error in the header, and the post-decoding header output portion starts to output the decoded header before the header error detection portion checks whether there is an error in the header.

11. A receiving method for receiving a packet including a header and a header error-detecting code, comprising the steps of:
receiving the header;
decoding the received header;
outputting the decoded header;
checking whether there is an error in the header by using the header error-detecting code; and
updating the output decoded header if an error is detected in the header.
